(19) United States
(12) Patent Application Publication
(10) Pub. No.: US 2007/0066482 A1
(43) Pub. Date: Mar. 22, 2007

(54) Polymer matrix for extending vase life of cut flowers

(76) Inventors: Henricus M. Thijssen, Houten (NL); Theodoor M. Slaghek, Rotterdam (NL); Roy C. Montijn, Amsterdam (NL); Johannes W. Timmemans, Ede (NL)

Correspondence Address: NIXON & VANDERHYE, PC, 901 NORTH GLEBE ROAD, 11TH FLOOR, ARLINGTON, VA, 22203, US

(21) Appl. No.: 10/564,783

(22) PCT Filed: Jul. 12, 2004
(86) PCT No.: PCT/NL04/00502

§ 371 Date: Jun. 16, 2006

(30) Foreign Application Priority Data
Jul. 14, 2003 (NL) 1023915

(51) Int. Cl. A01N 3/02

(52) U.S. Cl. 504/115

(57) ABSTRACT

The invention relates to a polymer matrix for extending the vase life of cut flowers, which matrix comprises a charged and crosslinked polymer, wherein the matrix, in the presence of water, forms a gel, which gel immobilizes bacteria on the basis of electrostatic interactions between the gel and the bacterial. Further, the invention relates to a gel obtained by contacting the polymer matrix according to the invention with a limited amount of water. Also, the invention relates to an envelope containing a particular amount of the matrix or gel according to the invention. The invention also relates to a care product for cut flowers which comprises the polymer matrix or the gel according to the invention.

The invention relates to a polymer matrix for extending the vase life of cut flowers, a gel which is obtained with the matrix, and an envelope containing an amount of the matrix or the gel.

It is known that active substances such as growth promoters and antimicrobial substances can be used in care products for cut flowers. Such products are normally a powder mixture of antimicrobial substances and growth promoters, which mixture is dissolved in vase water. However, these products have the disadvantage that a relatively large amount of the active substance is required to ensure that the concentration of the growth promoters and antimicrobial substance is the same throughout within the flower vase, and desired results can be obtained.

Surprisingly, a product has now been developed which can be used for the care of cut flowers, whereby no active substance or only a particularly small amount of active substance is needed to obtain the desired results.

Accordingly, the invention relates to a polymer matrix for extending the vase life of cut flowers, which matrix comprises a charged and crosslinked polymer, the matrix forming a gel in the presence of water, which gel immobilizes bacteria on the basis of electrostatic interactions between the gel and the bacteria.

Such a polymer matrix has the advantage that a gel can be obtained with it, as a result of which the flower stems are exposed to bacteria to a lesser extent, which results in a longer vase life of the cut flowers, even without the use of an active substance being necessary.

In a preferred embodiment of the present invention, the polymer matrix comprises a polymer decomposable by microorganisms and at least one active substance, while the gel to be formed is decomposable by microorganisms and, when it is in effect being so decomposed, releases the active substance to the environment. In this way, in a dosed manner, an active substance is released to the environment, while avoiding the situation where release of active substance also takes place when no microorganisms are present in the environment. In other words, the active substance will be released only when microorganisms are present and active in the environment. This is especially important for products whose storage life is limited by the presence of microorganisms.

The bacteria to be immobilized can be both gram-negative bacteria and gram-positive bacteria.

The polymer matrix according to the invention can comprise one or more different types of polymers.

The polymer matrix according to the invention can be used particularly suitably as a care product for cut flowers.

When the polymer matrix is used in a care product for cut flowers, the active substance can comprise an antimicrobial substance and/or a growth promoter. The polymer matrix can comprise two or more different active substances, for instance two or more antimicrobial substances and/or two or more different growth promoters. Preferably, the polymer matrix comprises at least two active substances, preferably at least one antimicrobial substance and at least one growth promoter.

A particularly great advantage of the polymer matrix according to the invention is that when the polymer matrix is used as a care product for cut flowers, no active substance or just a particularly small amount of active substance is needed to obtain good results. Compared with known care products for cut flowers, the needed amounts of active substance can now be reduced by no less than 90 percent. This is specifically important because in such products the antimicrobial substances used are often chemical products (biocides) which are subject to strict environmental requirements (Biocidal Products Directive 98/8/EC) and are increasingly at issue.

When the polymer matrix comprises an active substance, then in the presence of water first a gel can be formed on the bottom of the vase, after which the flowers to be used are placed with their cut surface in or just above the gel incorporating the active substances. To that end, for instance a dry mixture of the polymer and the active substance can be mixed with the water in the vase. Instead of using a dry mixture of the polymer and the active substance(s), it is also possible to use them in the form of a gel. The flowers then stand with their cut surface directly in or above the gel containing the active substance, so that considerably smaller amounts of active substance are needed to achieve desired results.

In another embodiment of the invention, with the polymer matrix, in the presence of water, first a gel is formed on the bottom of the vase, after which the at least one active substance is added, which active substance is attractively captured in the gel. The polymer matrix can be added to the water in the form of a dry powder or a gel, after which the active substance is added, for instance in the form of a dry powder. Then, the flowers to be used can be placed with their cut surface in or just above the thus obtained gel.

The charged and crosslinked polymer to be used in the matrix can be positively or negatively charged, depending on the choice of the active substance(s).

If the polymer matrix does not contain an active substance, the polymer matrix preferably comprises a positively charged and crosslinked polymer.

When the polymer matrix also contains an active substance, the polymer matrix preferably comprises a mixture of a positively charged and crosslinked polymer and a negatively charged and crosslinked polymer. Such a mixture has the advantage that in a solution with water a very airy volume is obtained, so that much less polymer matrix is needed to obtain a particular volume.

The polymer matrix can comprise a mixture of polymers which are decomposable by microorganisms and polymers which are not decomposable by microorganisms.

The polymer matrix according to the invention preferably comprises one or more polymers that are decomposable by microorganisms. Preferably, the matrix comprises one or more biopolymers. In a suitable embodiment, the matrix comprises one or more polymeric carbohydrates.

Preferably, polymeric carbohydrates from DP50 are used. These can be naturally occurring polymers such as starch (amylose, amylopectin), cellulose, fructans such as inulin and gums or derivatives thereof which can be formed, for instance, through phosphorylation or oxidation. The polymer matrix can comprise different types of carbohydrate. Preferably, the polymer matrix comprises one particular type of carbohydrate. Carbohydrates that are thus applicable are, for instance, glucose, fructose, sucrose, maltose, arabinose, mannose, galactose, lactose and oligomers and polymers of these sugars, cellulose, dextrins such as maltodextrin, agarose, amylose, amylopectin and gums, for instance guar.

Preferably, the polymer matrix comprises polymers having a viscosity of less than 14,000 cps. Polymers that can be suitably used in the present invention have a degree of substitution (ds) of 0.05-2.0. Preferably, they have a molecular weight of more than 30 kD.

The charged and crosslinked polymer that is used in the polymer matrix can be obtained by crosslinking corresponding polymers in a suitable manner. In this way, a three-dimensional lattice is obtained. In particular, the crosslinking is realized by ether and/or ester bonds. Crosslinking compounds that can be used are, for instance, divinyl sulfone, sodium trimetaphosphate, diepoxides and epichlorohydrin, although also enzymes can be used for this purpose. The amount of crosslinking compound to be used will depend on the type of polymer to be used.

The polymer matrix according to the invention can generally be prepared as follows:

(a) a charged polymer is used as starting material;

(b) the charged polymer is crosslinked with the aid of a crosslinking compound to form a polymer matrix;

(c) the obtained polymer matrix is gelled; and

(d) the obtained gel is washed in order to remove unreacted components.

The gel thus obtained in step (d) can be used directly. However, if a dry mixture of the polymer matrix is preferred, it is possible, after step (d), to form particles by pressing the gel through a sieve, and then drying the obtained particles. When an active substance is used, it can subsequently be added to the dry polymer matrix, or to the gel obtained in step (c).

Eligible for use as antimicrobial substance are: bacteriocins such as nisin and pediocin; metals or derived metals such as metal oxides, metal salts, metal complexes or alloys; antibiotics such as penicillin, erythromycin, ampicillin, isoniazid, tetracycline, sulfonamides and chloramphenicol; ethanol; hydrogen peroxide-producing enzymes such as oxidases; organic acids such as propionic acid and derived propionates, sorbic acid and derived sorbates, benzoic acid and derived benzoates, lactic acid; sodium diacetate; sodium nitrite; lysozymes and antimicrobial substances from herbs and spices.

Other particularly suitable antimicrobial substances are natural antimicrobial substances. Preferably, natural antimicrobial substances are used, and more preferably natural antimicrobial substances having the qualification “natural and/or foodgrade”, that is, they can be consumed without health hazard. Such antimicrobial substances are to be obtained, for instance, from herbs and/or spices. Also useful are vegetable toxins such as defensins, lectins, and antifungal proteins.

It will be clear to those skilled in the art that the choice of the active substance will depend on the specific use of the polymer matrix and the gel to be obtained.

In the field of cut flower care, preferably a polymer matrix is used which forms a transparent gel in the presence of water. The skilled person will understand that during use at least a portion of the polymer matrix will be decomposed and dissolved in the vase water. Preferably, during use, the entire matrix is decomposed and dissolved.

When the polymer matrix is used as a product for cut flower care, the matrix preferably comprises an antimicrobial substance and also one or more growth promoters such as nutrients and/or plant growth substances which are also released to the environment when the gel formed in the presence of water is decomposed by the microorganisms.

Such nutrients and plant growth substances are, for instance, minerals such as trace elements, glucose, growth hormones for plants, and citrate.

Preferably, the extent of release of the active substance to the environment is related to the extent to which the gel is decomposed by the undesired microorganisms present in the environment.

In a suitable embodiment of the present invention, in the polymer matrix, the ratio of the amounts of polymer (A) and active substance (B) is 0.005-6.0 (A/B), preferably 0.01-5.5, and still more preferably 0.015-5 (A/B).

In a suitable embodiment, the gel formed in the presence of water releases the active substance to the environment at a rate proportional to the release of specific enzymes by microorganisms. This rate accordingly depends on the type of enzyme to be used. A suitable rate, however, is 1-100 micromoles/day, and preferably 5-50 micromoles/day. Such a gel is preferably obtained from a polymer matrix which comprises polymer carbohydrates from DP50.

The invention further relates to a gel obtained by contacting a polymer matrix according to the invention with a limited amount of water. It will be clear to the skilled person that an amount of water should be used that effects the formation of a gel. The ratio of the amounts of polymer (A) and water (B) to be used, depends on the amount of charge and type of charge that is present on the polymer. Preferably, in the polymer matrix, the amounts of polymer (A) and water (B) are in a ratio of 0.001-3 (A/B), more preferably of 0.003-2.5 (A/B), and still more preferably of 0.005-2 (A/B). The gel according to the invention can also be suitably used with plant roots and other systems that are susceptible to infection with microorganisms, such as, for instance, nutrient substrates of rock wool or other material.

The invention also relates to a care product for cut flowers, comprising the polymer matrix or gel according to the invention.

Also, the invention relates to an envelope containing a particular amount of the matrix or gel according to the invention. Such an envelope can comprise a can, or bag or box of paper, paperboard or a film of a plastic material such as, for instance, a plastic film, or a metal foil.

In a suitable embodiment, the envelope contains 1-100 mg of antimicrobial substance, preferably 5-50 mg.

### EXAMPLE 1

### Synthesis of the Polymer Matrix with One Type of Biopolymer

A solution of 58 mg of NaOH in 90 ml of water was cooled to 0° C. To this was added 0.4 ml of divinyl sulfone. Slowly added to this were 15 grams of C-6 oxidized starch (degree of oxidation 30%). The solution changed overnight into a transparent colorless gel. This gel was pressed through a sieve of ca. 1 mm² mesh size, after which 0.5 liter of water was stirred through the gel, which was absorbed directly. After this, the gel was precipitated with 1 liter of ethanol and then washed twice with ethanol and once with acetone, after which the gel was dried in air.

### EXAMPLE 2

### Synthesis of the Polymer Matrix with Different Types of Biopolymers

A solution of 58 mg of NaOH in 90 ml of water was cooled to 0° C. To this was added 0.4 ml of divinyl sulfone. Directly after this, with vigorous stirring, a mixture of 10 grams of paselli 2 and 2.0 grams of the sodium salt of citrus pectin was added. After one night, the gel had formed. Next, this gel was pressed through a sieve of 1 mm² mesh size, after which 0.5 liter of water was stirred through the gel. After this, the gel was precipitated with 1 liter of ethanol, then washed with ethanol and acetone and dried in air.

### EXAMPLE 3

### Sensitivity of the Gels to Enzymatic Decomposition

To 10 ml of water, 50 mg of gel were added, followed by stirring at 37° C. Next, 0.1 ml of commercially available amylase was added (Termamyl, Novo Nordisk). Both gels dissolved within one hour.

### EXAMPLE 4

### Gel as Glucose Source for Cut Flowers

To four mixtures of 10 ml of water and 50 mg of gel, 100 units of commercially available exo-amylase were added at 0° C., 10° C., 15° C. and room temperature. Next, the formation of glucose was followed in time. The results show that the amount and rate of the formation of glucose depend on the temperature. However, in all four experiments, enough glucose is produced to enable the cut flowers to grow well and in a controlled manner.

### EXAMPLE 5

### Crosslinking Oxidized Starch with Divinyl Sulfone

To a solution of 52 mg of NaOH in 90 ml of water, 10 grams of C6-oxidized starch (degree of oxidation 30%) were added with stirring. Next, with the aid of an ice bath, the temperature was adjusted to 0-5° C. After this, 800 μl of divinyl sulfone were added with stirring. After 5 minutes of stirring, the solution was stored overnight at room temperature. The transparent and virtually colorless gel obtained was pressed through a sieve (1 mm²) and suspended in 0.5 liter of water, whereby the gel swelled strongly. Next, the gel was precipitated by adding 1 liter of ethanol. After that, the precipitate was washed twice with ethanol, once with acetone and finally dried in air. The yield was 9.0 grams with a free swell of 49.

### EXAMPLE 6

### Crosslinking Carboxymethylcellulose with Divinyl Sulfone

In 2.7 liters of water, 1.69 grams of NaOH and 300 grams of carboxymethylcellulose (low viscosity, Sigma) were dissolved. After cooling to 4° C., 11 ml of divinyl sulfone were added. After 5 minutes of stirring, the solution was stored for 3 days at room temperature. The gel formed was pressed through a sieve (1 mm²) and washed 10 times with water and three times with ethanol and subsequently dried in air. This yielded 242 grams of dry gel with a swelling capacity of 55 grams of water per gram of dry gel.

### EXAMPLE 7

### Crosslinking Oxidized Starch with Epichlorohydrin

With vigorous stirring, 15 grams of C6-oxidized starch (degree of oxidation 30%) were added to a solution of 1.0 gram of NaOH in 90 ml of water. Next, 2 ml of epichlorohydrin were added, followed by 15 minutes of further stirring. After this, the solution was stored for 3 days at 37° C. The gel formed was pressed through a sieve (1 mm²) and washed 10 times with 1 liter of water, 3 times with 1 liter of ethanol, 3 times with acetone and dried in air. The yield was 7.21 grams of dry gel with a free swell of 124 grams of water per gram of gel.

### EXAMPLE 8

### Crosslinking Oxidized Starch with Epichlorohydrin

With vigorous stirring, 45 grams of C6-oxidized starch (degree of oxidation 30%) were added to a solution of 3.6 grams of NaOH in 270 ml of water. Next, 9 ml of epichlorohydrin were added, followed by 15 minutes of further stirring. After this, the solution was stored for 3 days at 37° C. The gel formed was pressed through a sieve (1 mm²) and washed 10 times with 1 liter of water, 3 times with 1 liter of ethanol, 3 times with acetone and dried in air. The yield was 25 grams of dry gel with a free swell of 18 grams of water per gram of gel.

### EXAMPLE 9

### Crosslinking Cationic Starch with Epichlorohydrin

To a solution of 2.4 grams of NaOH in 480 ml of water, 120 grams of Paselli S.A.-2, and then 73 ml of glycidyltrimethylammonium chloride (70% in water) were added. After this, the reaction mixture was stirred for 2 hours at 60° C. After cooling, to 100 ml of this reaction mixture, 1 gram of NaOH and 3 ml of epichlorohydrin were added. The solution was stirred for 15 minutes and then stored for 3 days at 37° C. The gel obtained was pressed through a sieve (1 mm²) and washed 10 times with 1 liter of water, 3 times with 1 liter of ethanol and 3 times with acetone. The precipitate was dried in air. The yield was 18.05 grams of powder with a swelling capacity of 58 in water.

### EXAMPLE 10

### Crosslinking Cationic Starch with Epichlorohydrin

To a solution of 2.4 grams of NaOH in 480 ml of water, 120 grams of Paselli S.A.-2, and then 146 ml of glycidyltrimethylammonium chloride (70% in water) were added. After this, the reaction mixture was stirred for 2 hours at 60° C. After cooling, to 100 ml of this reaction mixture, 1.6 grams of NaOH and 5 ml of epichlorohydrin were added. The solution was stirred for 15 minutes and then stored for 3 days at 37° C. The gel obtained was pressed through a sieve (1 mm²) and washed 10 times with 1 liter of water, 3 times with 1 liter of ethanol and 3 times with acetone. The precipitate was dried in air. The yield was 22 grams of powder with a swelling capacity of 32 in water.

### EXAMPLE 11

### Crosslinking of Carboxymethylcellulose with Epichlorohydrin

A solution of 1.5 grams of NaOH in 160 ml of water was vigorously stirred while 15 grams of carboxymethylcellulose (medium viscosity, Sigma) and then 2.5 ml of epichlorohydrin were added. After 15 minutes of stirring at room temperature, the solution was stored for 3 days at a temperature of 37° C. After cooling to room temperature, the very tough and transparent gel was cut into pieces of about 1 cm. These gel pieces were preserved overnight in 3 liters of water. Nearly all of the water was thereby absorbed and colorless, transparent lumps were obtained that were hard and brittle. These were pressed through a sieve (1 mm²) and washed 10 times with 1 liter of water, 3 times with 1 liter of ethanol and 3 times with acetone and then dried in air. This resulted in 9.8 grams of dry gel having a free swell of 228 grams of water per gram of gel.

### EXAMPLE 12

### Crosslinking Oxidized Starch with Glycerol Diglycidyl Ether

With vigorous stirring, 1.0 gram of NaOH and 15 grams of C6-oxidized starch (degree of oxidation 30%) were dissolved in 90 ml of water. After this, 0.9 ml of glycerol diglycidyl ether was added, followed by 15 minutes of further stirring. Next, the solution was stored for 3 days at 37° C. The gel thereby formed was pressed through a sieve (1 mm²) and washed 10 times with 1 liter of water, 3 times with 1 liter of ethanol, 3 times with acetone and dried in air. The yield was 8.22 grams of dry gel with a free swell of 143 in water.

### EXAMPLE 13

### Crosslinking Oxidized Starch with Glycerol Diglycidyl Ether

With vigorous stirring, 3.6 grams of NaOH and 45 grams of C6-oxidized starch (degree of oxidation 30%) were dissolved in 270 ml of water. After this, 4.5 ml of glycerol diglycidyl ether were added, followed by 15 minutes of further stirring. Next, the solution was stored for 3 days at 37° C. The gel thereby formed was pressed through a sieve (1 mm²) and washed 10 times with 1 liter of water, 3 times with 1 liter of ethanol, 3 times with acetone and dried in air. The yield was 47 grams of dry gel with a free swell of 34 in water.

### EXAMPLE 14

### Crosslinking Cationic Starch with Divinyl Sulfone

To a solution of 2.4 grams of NaOH and 60 grams of Paselli SA-2 in 240 ml of water, 146 ml of glycidyltrimethylammonium chloride were added. Next, the reaction mixture was stirred for 4 hours at 70° C. After cooling to 4° C., to 300 ml of the resulting reaction mixture, 10 grams of C6-oxidized starch (DO 30%) and 20 grams of dextran (molecular weight of 500 kD, Pharmacia) were added. With cooling in an ice bath, next, 3 ml of divinyl sulfone were added, after which the solution was stored for 3 days at room temperature. The gel formed was pressed through a sieve (1 mm²) and suspended in 1 liter of water. With vigorous stirring, 1.5 liters of acetone were added. As a result, the gel started to shrink and to sediment slowly. After 2 hours, 1.3 liters of solution were decanted off. After this, 0.5 liter of acetone was added, so that the gel precipitated fast. Next, the gel was washed three times with acetone and dried in air. This resulted in 104 grams of dry gel with a swelling capacity of 47 grams of water per gram of dry gel.

### EXAMPLE 15

### Crosslinking Carboxymethylcellulose with Divinyl Sulfone

To a solution of 1.6 grams of NaOH in 2700 ml of water/ice, with vigorous stirring, 300 mg of carboxymethylcellulose (low viscosity, Sigma) were added and then 12 ml of divinyl sulfone. The solution was stored for 3 days at room temperature. The tough transparent gel was pressed through a sieve (1 mm²) and suspended in 2 liters of water. After precipitation with 10 liters of ethanol, the precipitate was washed twice with ethanol, twice with acetone and then dried in air. The yield was 272 grams of dry gel with a swelling capacity of 58 grams per gram of dry gel.

### EXAMPLE 16

### Vase Tests with Red Roses and Gerberas

The gels used were first washed and dried again. To that end, 20 grams of dry gel were suspended in 2 liters of water. To this were added 50 ml of acetic acid/150 ml of water. After 1 hour of stirring, the gel was washed 10 times with 2 liters of water. The water was removed by draining on a nylon sieve. Next, the gel was precipitated by adding 5 liters of ethanol. After this, the gel was washed three times with ethanol and three times with acetone. Finally, the gel was dried in air. This typically gives a yield of 15-20 grams.

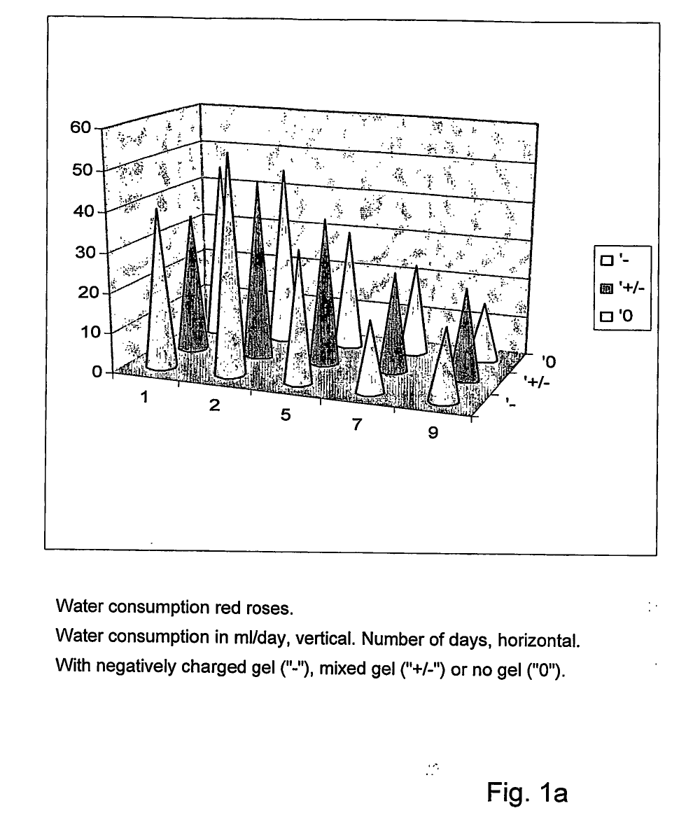

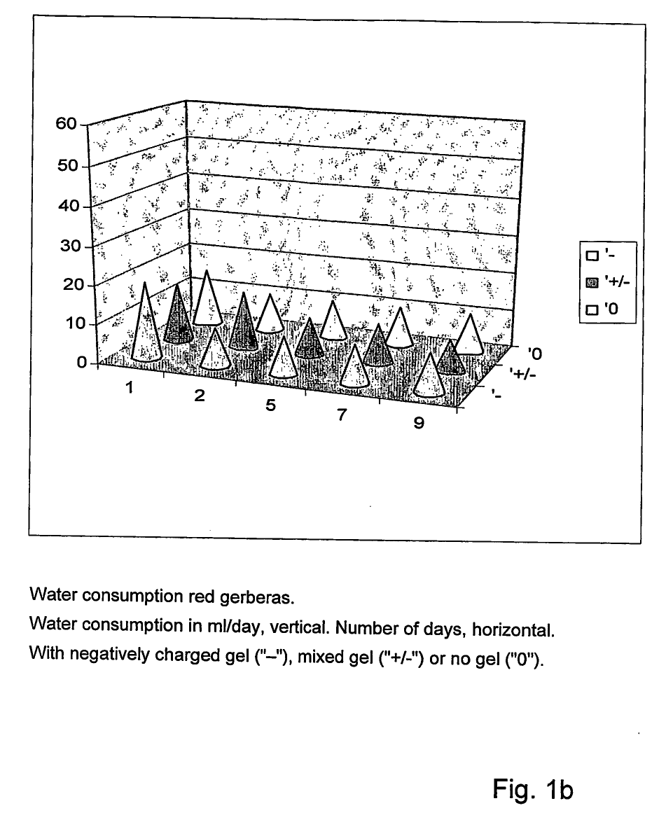

Red roses and gerberas were used, with three vase fillings for each and three flowers per vase of 300 ml. The following three vase fillings were used: 1) 2 grams of gel from Example 15 (negatively charged) and vase medium; 2) 0.75 grams of gel from Example 15, 0.75 grams of gel from Example 14 (positively charged) and vase medium; and 3) vase medium alone. After 5 and after 9 days the volume was replenished to 300 ml with the same solutions (without gel). For the vase medium of standard hardness, 19 grams of glucose, 2 grams of citric acid, 238 mg of MgCl₂.6H₂O, 554 mg of CaCl₂.2H₂O and 560 mg NaHCO₃ were dissolved in 2 liters of demi water. The water consumption per vase was measured after 1, after 2, after 5, after 7 and after 9 days. After 1, 5, 7, 14 and 21 days, the flowers were analyzed. FIGS. 1a and 1b represent the water consumption per day.

The analysis of the flowers gave the following picture. After 1 day, there are no problems yet, but after 5 days, 2 roses in the blank have a hanging head. This does not hold for the other roses. The positively/negatively charged mixed gel (“+/−gel”) then begins to fall dry, and all roses still look good. After 7 days, in the gerberas, the stem in the water begins to rot. All roses now begin to have problems, except the roses in the “+/−gel”. After 2 weeks, the gerberas have finished flowering. The roses in the “+/−gel” still look good, but the flowers begin to show some damage. After 3 weeks, the leaves of the roses in the “+/−gel” are still in good condition, but the flowers are clearly damaged. The gel has fallen dry down to the bottom and has filled with air, but still looks wet. Despite the presence of a gel, the roses could apparently take up all the free water.

FIG. 1a shows that the water consumption in roses slowly decreases over time. The water consumption does not appear clearly dependent on the presence of a negatively charged gel or a “+/−gel”. This also shows that the gel does not impede the water uptake of the flowers.

In a corresponding manner, vase tests were carried out with the gels of Examples 8, 13, 6, 10 and 9. However, 2 grams of dry gel were added to vases with 1 liter of vase medium and three roses. This gave the same picture. The presence of gel proves not to be an impediment to the water uptake. On the other hand, there was a clear improvement of vase life. A significant reduction of the vase water becoming turbid was observed.

1. A care product for cut flowers comprising a polymer matrix which comprises a charged and crosslinked carbohydrate, wherein the matrix forms a gel in the presence of water, which gel immobilizes bacteria on the basis of electrostatic interactions between the gel and the bacteria.

2. A product according to claim 1, wherein the carbohydrate is a positively charged and crosslinked carbohydrate.

3. A product according to claim 1, wherein the carbohydrate and the gel to be formed are decomposable by microorganisms.

4. A product according to claim 3, wherein the carbohydrate is a carbohydrate from DP50.

5. A product according to claim 1, wherein the carbohydrate comprises glucose, fructose, sucrose, maltose, arabinose, mannose, galactose, lactose or oligomers and polymers of these sugars, dextrins, agarose, amylose, amylopectine or gum.

6. A product according to claim 1, wherein the matrix further comprises one active substance, and wherein the gel, when it is being decomposed by the microorganisms, releases the active substance to the environment.

7. A product according to claim 6, comprising at least two active substances.

8. A product according to claim 7, comprising at least one antimicrobial substance and at least one growth promoter.

9. A product according to claim 1, which, in the presence of water, forms a transparent gel.

10. A product according to claim 6, wherein the antimicrobial substance has the qualification “natural and/or foodgrade”.

11. A product according to claim 6, wherein the extent of release of the antimicrobial substance to the environment is related to the extent to which the gel formed in the presence of water is decomposed by the microorganisms present in the environment.

12. A product according to claim 6, wherein the ratio between the amounts of polymer (A) and active substance (B) is 0.005-6.0 (A/B).

13. A product according to claim 6, wherein the gel formed in the presence of water releases the active substance to the environment at a rate of 1-100 micromoles/day.

14. A gel obtained by contacting the care product for cut flowers according to claim 1 with a limited amount of water.

15. A gel according to claim 14, wherein the ratio between the amounts of matrix (A) and water (B) is 0.001-3 (A/B).

16. An envelope containing a particular amount of the care product for cut flowers or gel according to claim 1.

17. Use of the care product or gel according to claim 1 for extending the vase life of cut flowers.
